(19) United States
(12) Patent Application Publication
(10) Pub. No.: US 2016/0171952 A1
(43) Pub. Date: Jun. 16, 2016

(54) HIGH RESOLUTION DISPLAY AND DRIVER CHIP THEREIN

(71) Applicant: FORCELEAD TECHNOLOGIES CORP., HSINCHU COUNTY 302 (TW)

(72) Inventors: CHIH-LUNG KUO, HSINCHU COUNTY 302 (TW); WEN-LIN YANG, HSINCHU COUNTY 302 (TW)

(21) Appl. No.: 14/972,607

(22) Filed: Dec. 17, 2015

Related U.S. Application Data
(60) Provisional application No. 62/065,806, filed on Oct. 20, 2014.

(51) Int. Cl. G09G 5/00

(52) U.S. Cl. CPC G09G 5/00; G09G 2310/0289; G09G 2310/0254; G09G 2310/027; G09G 2310/0275; G09G 2310/061

(57) ABSTRACT

The present invention provides a driver chip comprising a gate driving module and a source driving module both coupled to a display panel. A plurality of scan lines and a plurality of data line of the display panel scan and drive the display panel for displaying a frame. The source driving module is coupled to the mainboard and receives the positive and negative voltage of the mainboard for generating a source signal to the display panel

### FIELD OF THE INVENTION

The present invention relates generally to a high resolution display, and particularly to a driver chip applied to a high resolution display.

### BACKGROUND OF THE INVENTION

As the industry develops, digital tools such as mobile phones, digital cameras, notebook computers, desktop computers are developing towards the trend of more convenience, snore functions, and designs that are more appealing. The displays of these electronic products are indispensable human-machine interfaces and are able to facilitate operational convenience for users. As the image processing technology develops, in order to fully utilize frames, the resolution of displays must be increased. Up to date, products with 5 K resolution have been announced.

The circuit design inside a high resolution display is complicated and requiring multiple voltages. Thereby, multiple voltages are required for a driver chip for high resolution display. According to the prior art, in order to supply various voltages to a driver chip, multiple capacitors are disposed on the flexible printed circuit (FPC) for booting voltage and supplied to the internal module of tire driver chip. Nonetheless, the capacitors on FPC result in an increase in cost.

Accordingly, in order to use no capacitor on FPC, the present invention provides a high solution display for reducing the cost of display.

### SUMMARY

An objective of the present invention is to provide a driver chip, which receives the voltage supplied by the mainboard directly and drives the display panel.

Another objective of the present invention is to provide a high resolution display with FPC having no capacitor and thus reducing display cost.

In order to achieve the objectives and efficacies as described above, the present invention discloses a driving circuit for a high resolution display.

According to an embodiment of the present invention, a driver chip is provided. The driver chip comprises a gate driving module and a source driving module. The gate driving module is coupled to a display panel and generates a plurality of scan signals, which scan the display panel via a plurality of scan lines. The source driving module is coupled to the display panel and drives the display panel via a plurality of data lines. The source driving module is coupled to a mainboard and receives a positive voltage and a negative voltage generated by the mainboard for generating a plurality of source signals to the display panel.

According to another embodiment of the present invention, a high resolution display is provided. The high resolution display comprises a display panel. The display panel comprises a plurality of data lines and a plurality of scan lines. The display comprises a driver chip and a mainboard. The driver chip comprises a source driving module and a gate driving module. The source driving module is coupled to the plurality of data lines. The gate driving module is coupled to the plurality of scan lines. The mainboard generates a positive voltage and a negative voltage. The mainboard is coupled to the drier chip. The source driving module receives the positive or negative voltage and generates a plurality of source signals for the display panel. The gate driving module generates a plurality of scan signal and scans the display for displaying a frame.

### BRIEF DESCRIPTION OF THE DRAWINGS

FIG. 1 shows a schematic diagram of the driver chip according a first embodiment of the present invention;

FIG. 2 shows a schematic diagram of the driver chip in a high resolution display according an embodiment of the present invention;

FIG. 3 shows s schematic diagram of the driver chip according a second embodiment of the present invention; and

FIG. 4 shows a schematic diagram of the driver chip according a third embodiment of the present invention.

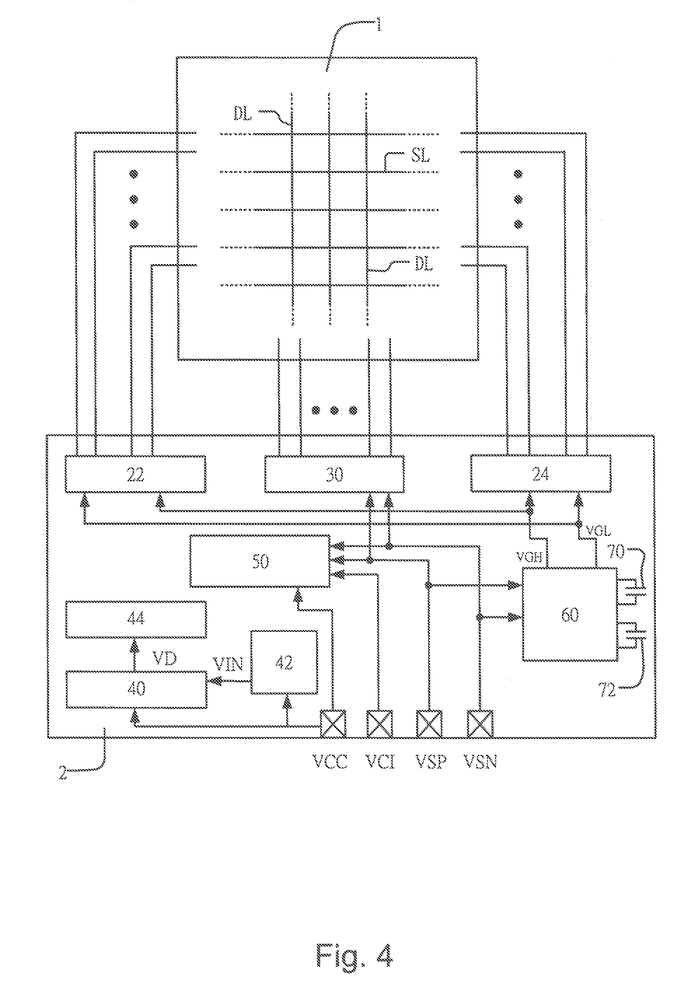

### DETAILED DESCRIPTION

In order to make the structure and characteristics as well as the effectiveness of the present invention to be further understood and recognized, the detailed description of the present invention is provided as follows along with embodiments and accompanying figures.

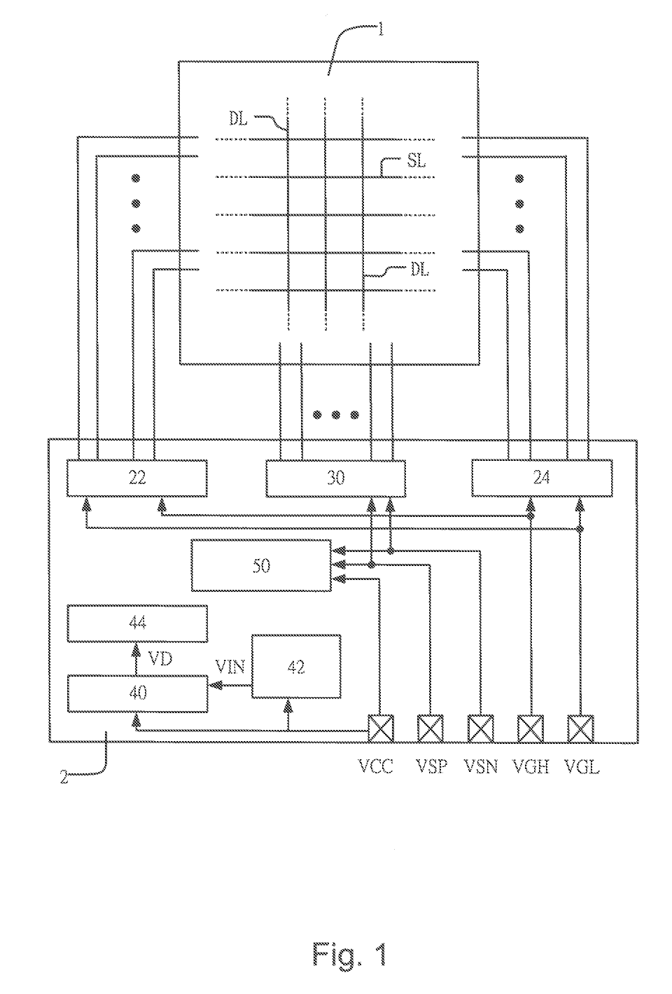

Please refer to FIG. 1, which shows a schematic diagram of the driver chip according a first embodiment of the present invention. As shown in the figure, the driver chip 2 according to the present invention comprises gate driving module 22, 24 and a source driving module 30. The gate driving modules 22, 24 are coupled to a display panel 1 and generate a plurality of scan signals. The plurality of scan signals scan the display panel via a plurality of scan lines SL of the display panel 1. Likewise, the source driving module 30 is coupled to the display panel 1 and drives the display panel 1 via a plurality of data lines DL of the display panel 1.

In addition, the driver chip 2 is further coupled to a mainboard 4, which generates a positive voltage VSP, a negative voltage VSN, a scan voltage VGH, and a cutoff voltage VGL. The source driving module 30 is coupled to the mainboard 4, receives the positive and negative voltages VSP, VSN, and uses them as a source input voltage for generating a plurality of source signals. The plurality of source signals drives the display panel 1 via the plurality of data lines DL. The source input voltage of the source driving module 30 is equal to the positive voltage VSP or the negative voltage VSN. Besides, the gate driving modules 22, 24 are coupled to the mainboard 4 as well. The scan voltage VGH and the cutoff voltage VGL generated by the mainboard 4 can be supplied to the driver chip 2 directly. Thereby, the gate driving modules 22, 24 receive the scan voltage VGH directly and generate the plurality of scan signals. The plurality of scan signals then scan the display panel 1 via the plurality of scan lines SL or receive the cutoff voltage directly for stopping scanning the display panel 1. Hence, the mainboard 4 according to the present invention generates the voltages directly required by the driver chip 2 and outputs them to the driver chip 2 directly. Consequently, according to the present invention, it is not necessary to dispose capacitors on the FPC for generating the voltages required by the driver chip 2. Then the display costs can be lowered.

The driver chip 2 according to the present invention supplies the positive voltage VSP, the negative voltage VSN, the scan voltage VGH, and the cutoff voltage VGL generated by the mainboard 4 to the source driving module 30 and the gate driving modules 22, 24 directly and generates the plurality of source signals and scan signals to the display panel 1 for displaying the frame. Thereby, even for the high resolution display panel 1, the voltages generated by the mainboard 4 can be supplied directly to the source driving module 30 and the gate driving modules 22, 24. No additional capacitor is required for generating various voltages required by the driver chip 2. Consequently, the display costs can be lowered and the layout area can be reduced.

Please refer again to FIG. 1. The driver chip 2 can further comprises a selection circuit 40, a reference voltage circuit 42, a digital module 44, and other circuit 50. The selection circuit 40 is coupled to the reference voltage circuit 42 and the mainboard 4, and receives a reference voltage VIN generated by the reference voltage circuit 42 and a supply voltage VCC generated by the mainboard 4. The digital module 44 is coupled to the selection circuit 40 and receives a supply voltage VD. The reference voltage circuit 42 can be a low dropout regulator (LDO). The selection circuit 40 selects one of the supply voltage VIN and the reference voltage VCC to be the supply voltage VD. The other circuit 50, likewise, can receive the supply voltage VCC, the voltage VCI, the positive voltage VSP, or the negative voltage VSN directly. The other circuit 50 according to the embodiments of the present invention includes, for example, the protection circuit or the timing controller of the driver chip 2. The other voltages required by the other circuit 50 can be generated by the mainboard 4 as well. The operating method will not be described again.

The digital module 44 inside the driver chip 2 is driven by the supply voltage VD. The supply voltage VD is selected by the selection circuit 40 from the supply voltage VCC generated by the mainboard 4 and the reference voltage VIN generated by the reference voltage circuit 42. Thereby, when the supply voltage VCC generated by the mainboard 4 can meet the requirements of the digital module 44, the digital module 44 receives the supply voltage VCC generated by the mainboard 4 directly for driving the display panel 1. Otherwise, the reference voltage VIN is received for driving the display panel 1.

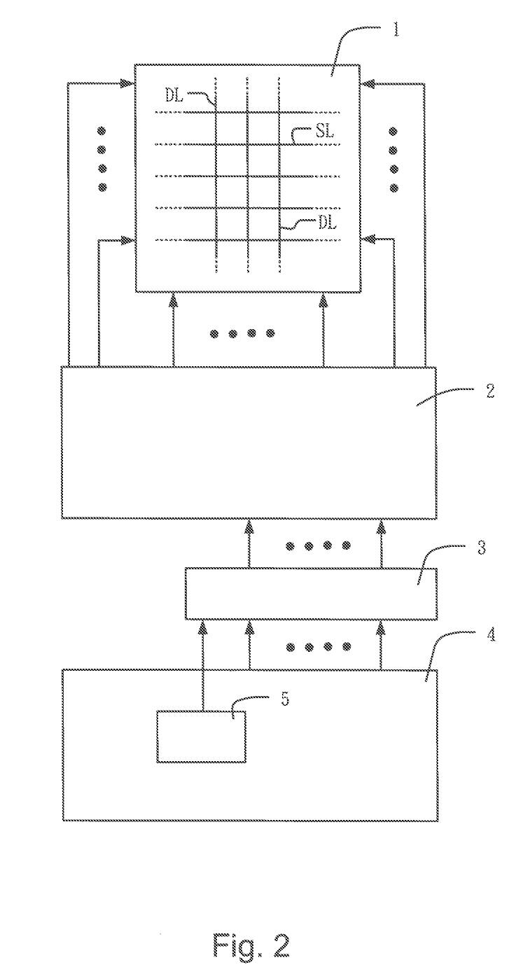

Please refer to FIG. 2, which shows a schematic diagram of the driver chip in a high resolution display according an embodiment of the present invention. As shown in the figure, as FPC 3 can be further included between the driver chip 2 and the mainboard 4. The mainboard 4 is coupled to the driver chip 2 via the FPC 3. In addition, the positive voltage VSP, the negative voltage VSN, the scan voltage VGH, the cutoff voltage VGL, and the supply voltage are supplied to the driver chip 2 through the FPC 3 without any capacitor. Moreover, the mainboard 4 can further include a control circuit 5, which controls the selection circuit 40 and thus controlling the voltage level of the supply voltage VD received by the digital module 44. The control circuit 5 can judge if the supply voltage VCC is lower than or higher than a threshold voltage before it controls the switching of the selection circuit 40 and determines the supply voltage VD. For example, when the supply voltage VCC is lower than the threshold voltage, the control circuit 5 controls the selection circuit 40 to output the supply voltage VCC to the digital module 44. As the supply voltage VCC is higher than the threshold voltage, the control circuit 5 controls the selection circuit 40 to output the reference voltage VIN to the digital module 44. Besides, a control signal of the control circuit 5 can be transmitted to the driver chip 2 via the FPC 3 as well.

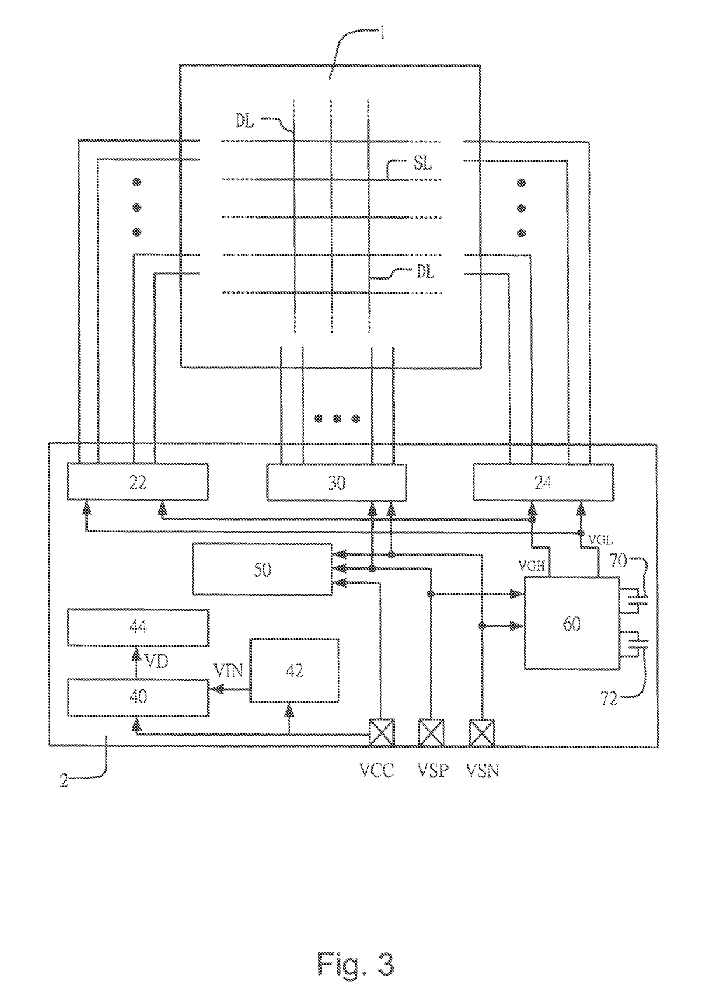

Please refer to FIG. 3, which shows a schematic diagram of the driver chip according a second embodiment of the present invention. As shown in the figure, the driver chip 2 can includes a charge pump 60, which includes one or more capacitor 70 and receives the positive voltage VSP and the negative voltage VSN supplied from the mainboard 4. The charge pump 60 uses the positive voltage VSP and the negative voltage VSN in generating the scan voltage VGH and the cutoff voltage VGL, so that the gate driving modules 22, 24 receive the scan voltage VGH to generate the scan signals for scanning the display panel 1 and the cutoff voltage VGL for stopping scanning. Thereby, according to the present embodiment, the voltage levels of the scan voltage VGH and the cutoff voltage VGL generated by the charge pump 60 are not equal to the voltage levels of the positive and negative voltages VSP, VSN.

Moreover, the mainboard 4 can further include a power supply circuit, which generates a plurality of supply voltages used for generating the scan voltage VGH and the cutoff voltage VGL, respectively. Thereby, in addition to generating the scan voltage VGH and the cutoff voltage VGL using the positive and negative voltages VSP, VSN, they can be generated using other power supply circuits and other voltage generating circuits on the mainboard 4 as well. Accordingly, the present invention does not limit the method for generating the scan voltage VGH and the cutoff voltage VGL.

According to the present invention, although a plurality of capacitors 70, 72 are added to the driver chip 2, the driver chip 2 still can selectively use the voltages supplied by the mainboard 4. Nonetheless, if the mainboard 4 supplies only the positive and negative voltages VSP, VSN, the charge pump 60 can used for charging the capacitors 70, 72 according to fee positive and negative voltages VSP, VSN and generating the scan voltage VGH and the cutoff voltage VGL for the gate driving modules 22, 24. In addition, as applied to a high resolution display, because the power consumption of the gate driving modules 22, 24 is lower than the source driving module 30, the charge pump 60 does not require large capacitors 70, 72. Hence, instead of on the FPC 3, the capacitors 70, 72 can be disposed on the driver chip 2 directly.

To sum up, the driver chip according to the present invention includes the gate driving modules and the source driving module. The source driving module generates the source input voltage required by the source signals and supplied by the positive and negative voltages provided by the mainboard directly. The gate driving modules uses the mainboard to provide the scan voltage and the cutoff voltage directly for generating the scan signals. Alternatively, the positive and negative voltages generated by the mainboard and be used by the charge pump for charging and generating the scan voltage and the cutoff voltage. Thereby, the number of capacitors disposed on the FPC can be reduced and thus lowering the display costs. In addition to the gate and source driving modules, the driver chip further includes the digital module. The supply voltage required by the digital modules is selected by the selection circuit from the supply voltage provided by the mainboard and the reference voltage provided by the reference circuit. It prevents inability of normal operation due to an excessively high supply voltage. According to the present invention, the voltage generated by the mainboard are adopted directly and used as the various voltages required by the driver chip. Hence, no capacitor is required on the FPC, and the volume and costs of the driver chip as well as the display can be both reduced.

Accordingly, the present invention conforms to the legal requirements owing to its novelty, nonobviousness, and utility. However, the foregoing description, is only embodiments of the present invention, not used to limit the scope and range of the present invention. Those equivalent changes or modifications made according to the shape, structure, feature, or spirit described in the claims of the present invention are included in the appended claims of the present invention.

1. A driver chip, comprising:
a gate driving module, coupled to a display panel generating a plurality of scan signals, and scanning said display panel via a plurality of scan lines;
a source driving module, coupled to said display panel, and driving said display panel via a plurality of data lines;
where said source driving module is coupled to a mainboard, and receives a positive voltage and a negative voltage generated by said mainboard for generating a plurality of source signal to said display panel.

2. The driver chip of claim 1, wherein said mainboard further generates a scan voltage and a cutoff voltage; said gate driving module receives said scan voltage and generates said plurality of scan signals; said plurality of scan signals scan said display panel via said plurality of scan lines; and said gate driving module receives said cutoff voltage and stops scanning said display panel.

3. The driver chip of claim 1, wherein said mainboard generates and outputs said positive voltage or said negative voltage to the input of said source driving module, and uses said positive voltage or said negative voltage as a source input voltage of said source driving module; the voltage level of said source input voltage is equal to the voltage level of said positive voltage or said negative voltage; said positive voltage and said negative voltage are further used for generating a scan voltage and a cutoff voltage; said gate driving module receives said scan voltage and generates said plurality of scan signals; said plurality of scan signals scans said display panel via said plurality of scan lines; said gate driving module receives said cutoff voltage and stops scanning said display panel; and the voltage level of said scan input voltage is not equal to the voltage levels of said positive voltage and said negative voltage.

4. The driver chip of claim 3, and further comprising a charge pump and one or more capacitors; said charge pump coupled between said mainboard and said gate driving module; and said charge pump using said capacitor to raise the voltage levels of said positive voltage and said negative voltage for generating said scan voltage and said cutoff voltage to said gate driving module.

5. The driver chip of claim 2 or 3, and further comprising a selection circuit, a reference voltage circuit, and a digital module; said digital module coupled to said selection circuit and receiving a supply voltage for controlling said display panel; said selection circuit coupled to said mainboard and said reference voltage circuit; and according to a supply voltage generated by said mainboard, said selection circuit determining outputting said supply voltage generated by said mainboard or a reference voltage generated by said reference voltage circuit as said supply voltage of said digital module.

6. The driver chip of claim 5, wherein a control circuit of said mainboard is coupled to said selection circuit; when said supply voltage is lower than a threshold voltage, said control circuit controls said selection circuit to output said supply voltage to said digital module; and when said supply voltage is higher than said threshold voltage, said control circuit controls said selection circuit to output said reference voltage to said digital module;

7. The driver chip of claim 1, wherein said mainboard is coupled to said driver chip via a flexible printed circuit having no capacitor.

8. A high resolution display, including a display panel having a plurality of data lines and a plurality of scan lines, and comprising:
a driver chip, having a source driving module and a gate driving module, said source driving module coupled to said plurality of data lines, and said gate driving module coupled to said plurality of scan lines; and
a mainboard, generating a positive voltage and a negative voltage, coupled to said driver chip, said source driving module receiving said positive voltage and said negative voltage and generating a plurality of source signals to said display panel, and said gate driving module generating a plurality of scan signals and scanning said display panel for displaying a frame.

9. The display of claim 8, wherein said mainboard further generates a scan voltage and a cutoff voltage; said gate driving module receives said scan voltage and generates said plurality of scan signals; said plurality of scan signals scan said display panel via said plurality of scan lines; and said gate driving module receives said cutoff voltage and stops scanning said display panel.

10. The display of claim 8, wherein said mainboard generates and outputs said positive voltage or said negative voltage to the input of said source driving module, and uses said positive voltage or said negative voltage as a source input voltage of said source driving module; the voltage level of said source input voltage is equal to the voltage level of said positive voltage or said negative voltage; said positive voltage and said negative voltage are further used for generating a scan voltage and a cutoff voltage; said gate driving module receives said scan voltage and said cutoff voltage for starting or stopping scanning said display via said plurality of scan lines; and the voltage levels of said scan voltage and said cutoff voltage are not equal to the voltage levels of said positive voltage and said negative voltage.

11. The display of claim 10, wherein said driver chip further comprises a charge pump and one or more capacitors; said charge pump is coupled between said mainboard and said gate driving module; and said charge pump uses said capacitor to raise the voltage levels of said positive voltage and said negative voltage for generating said scan voltage and said cutoff voltage to said gate driving module.

12. The display of claim 9 or 10, wherein said driver chip further comprises a selection circuit, a reference voltage circuit, and a digital module; said digital module is coupled to said selection circuit and receives a supply voltage for controlling said display panel; said selection circuit is coupled to said mainboard and said reference voltage circuit; and according to a supply voltage generated by said mainboard, said selection circuit determines outputting said supply voltage generated by said mainboard or a reference voltage generated by said reference voltage circuit as said supply voltage of said digital module.

13. The display of claim 12, and further comprising a control circuit coupled to said selection circuit; when said supply voltage is lower than a threshold voltage, said control circuit controlling said selection circuit to output said supply voltage to said digital module; and when said supply voltage is higher than said threshold voltage, said control circuit controlling said selection circuit to output said reference voltage to said digital module;

14. The display of claim 8, and further comprising a flexible printed circuit, coupled between said mainboard and said driver chip for receiving and supplying said positive voltage and said negative voltage to said driver chip.

15. The display of claim 14, wherein no capacitor is disposed on said flexible printed circuit.
